(19) United States
(12) Patent Application Publication
(10) Pub. No.: US 2021/0382810 A1
(43) Pub. Date: Dec. 9, 2021

(54) TEST DATA GENERATION APPARATUS, TEST DATA GENERATION METHOD AND PROGRAM

(71) Applicant: NIPPON TELEGRAPH AND TELEPHONE CORPORATION, Tokyo (JP)

(72) Inventors: Hiroyuki KIRINUKI, Tokyo (JP); Toshiyuki KURABAYASHI, Tokyo (JP); Haruto TANNO, Tokyo (JP)

(73) Assignee: NIPPON TELEGRAPH AND TELEPHONE CORPORATION, Tokyo (JP)

(21) Appl. No.: 17/288,352

(22) PCT Filed: Oct. 11, 2019
(86) PCT No.: PCT/JP2019/040308

§ 371 Date: Apr. 23, 2021

(30) Foreign Application Priority Data
Oct. 25, 2018 (JP) 2018-200642

(51) Int. Cl. G06F 11/36

(52) U.S. Cl. CPC G06F 11/3684; G06F 11/3688; G06F 11/3692

(57) ABSTRACT

A test data generation device configured to generate test data of a test related to screen transitions provided by a web application, the test data generation device including a selection reception unit configured to receive selection of one or more screen transitions among the screen transitions; an extraction unit configured to extract a constraint from a source code of the web application by analyzing the source code by using a description specification of a constraint set or defined by a framework of the web application; and a generation unit configured to generate a plurality of test data that cover test standpoints of equivalence partitioning and boundary value analysis by using the constraint of an input form included in a screen of a transition source of the one or more screen transitions that are selected.

### TECHNICAL FIELD

The present invention relates to a test data generation device, a test data generation method, and a program.

### BACKGROUND ART

Techniques of automatically generating test cases (i.e., input values used for a test) are known in the related art as a method of supporting software tests for a web application and the like.

For example, as a technique of automatically generating a test case, symbolic execution and dynamic symbolic execution are known (Non Patent Literature 1). The symbolic execution is a technique of deriving a condition of an input value for passing through a given path by executing a program in a pseudo-manner with a symbolized input. On the other hand, the dynamic symbolic execution is a method of a combination of symbolic execution and program execution using a specific value. In the symbolic execution and the dynamic symbolic execution, input values of tests that cover the paths can be generated.

In addition, for example, a technique of modeling the behavior of an application and exhaustively generating input values of a test from the model is also known (Non Patent Literature 2). This method requires manual description of the model, but can accurately perform a test whether the application conforms to the model.

### CITATION LIST

### Non Patent Literature

Non Patent Literature 1: Koushik Sen, Darko Marinov, and Gul Agha. 2005. CUTE: a concolic unit testing engine for C. In Proceedings of the 10th European software engineering conference held jointly with 13th ACM SIGSOFT international symposium on Foundations of software engineering (ESEC/FSE-13). ACM, New York, N.Y., USA, 263-272.
DOI=http://dx.doi.org/10.1145/1081706.1081750
Non Patent Literature 2: Haruto Tanno, Xiaojing Zhang: “Automatic Test Data Generation Based on Domain Testing”, Information Processing Society of Japan Technical Report, software engineering, vol. 2014-SE-186, no. 6, pp. 1-8, Nov. 11, 2014

### SUMMARY OF THE INVENTION

### Technical Problem

However, in the techniques described in Non Patent Literature 1 and Non Patent Literature 2, it is difficult to automatically acquire constraints related to common input values. Note that the constraint refers to a condition that should be independently satisfied by a single input value, a condition that should be satisfied among a plurality of input values, and the like.

For example, in the symbolic execution and the dynamic symbolic execution, analysis across the application is difficult since data exchange is typically performed across multiple programming languages and DBs (databases) in a web application. In addition, for example, although it is common to perform tests in accordance with the user's use cases in a GUI test or the like, the input values are generated to cover the paths in the symbolic execution or the dynamic symbolic execution, and consequently a test case that is improper as the test standpoint may be generated.

In addition, for example, in a method that models the behavior of an application, it is necessary to describe a constraint in the model by hand, which is time-consuming and makes it difficult to perform the description itself when the number of constraints is large.

As such, it has been difficult to solve the constraint and generate an input value to be provided as a test case. In view of this, it is conceivable that person-hours spent on testing can be reduced when the constraint can be automatically acquired and the input value to be provided as a test case can be generated from the constraint.

In light of the foregoing, an object of the present invention is to reduce the person-hours spent on testing for a web application.

### Means for Solving the Problem

To achieve the above object, a test data generation device of an embodiment of the present invention is configured to generate test data of a test related to screen transitions provided by a web application, the test data generation device including a selection reception unit configured to receive selection of one or more screen transitions among the screen transitions; an extraction unit configured to extract a constraint from a source code of the web application by analyzing the source code by using a description specification of a constraint set or defined by a framework of the web application; and a generation unit configured to generate a plurality of test data that cover test standpoints of equivalence partitioning and boundary value analysis by using the constraint of an input form included in a screen of a transition source of the one or more screen transitions that are selected.

### Effects of the Invention

Person-hours spent on testing of a web application can be reduced.

### BRIEF DESCRIPTION OF DRAWINGS

FIG. 1 is a diagram illustrating an example of an overall configuration of a system according to an embodiment of the present invention.

FIG. 2 is a diagram illustrating an overview of a variation generation of a test script.

FIG. 3 is a diagram illustrating an example of a hardware configuration of a client device according to the embodiment of the present invention.

FIG. 4 is a diagram illustrating an example of a functional configuration of the client device according to the embodiment of the present invention.

FIG. 5 is a flowchart illustrating an example of a variation generation process of a test script corresponding to a target transition.

FIG. 6 is a diagram illustrating an example of a screen transition.

FIG. 7 is a flowchart illustrating an example of a process of extracting a constraint.

FIG. 8 is a flowchart illustrating an example of a process of generating an input value.

FIG. 9 is a diagram illustrating an example of an input form.

FIG. 10 is a flowchart illustrating an example of a process of generating a test script group corresponding to a target transition.

### DESCRIPTION OF EMBODIMENTS

An embodiment of the present disclosure will be described below with reference to the drawings. Generally, in the embodiment of the present invention, a method of automatically generating a variation (i.e., a variation of an input value for a test through execution of a test script) of a test script for a test of equivalence partitioning and boundary value analysis, which are important test standpoints in a test of a web application, is described. Here, the test script refers to a script for a test of a certain test case, and is, for example, data in which an operation command to a screen and an input value entered or set to an input form included in the screen are described. Note that in the embodiment of the present invention, it is assumed that a screen transition test for testing transitions between screens provided by a web application is performed.

When the operation command described in the test script is automatically executed, a test involving a screen operation is automated. Note that the input value in the embodiment of the present invention is data used as an input in a test of a web application, and therefore may be referred to also as test data or the like.

In the related art, test cases of equivalence partitioning and boundary value analysis are often designed by a user who knows the specifications of the web application by taking the time, for example. With the techniques described in the embodiment of the present invention, a variation of a test script of a test of equivalence partitioning and/or boundary value analysis can be generated, and therefore the person-hours required for the test (e.g., a regression test and the like) can be reduced.

Overall Configuration

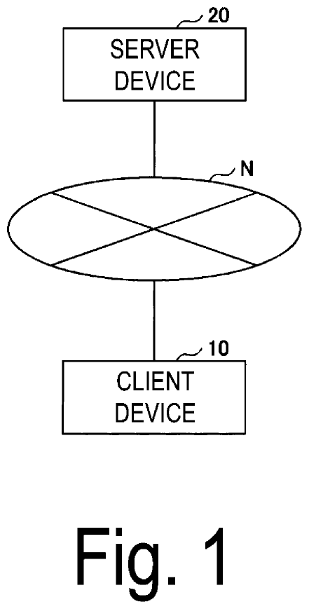

First, an overall configuration of a system according to the embodiment of the present invention will be described with reference to FIG. 1. FIG. 1 is a diagram illustrating an example of the overall configuration of the system according to the embodiment of the present invention.

As illustrated in FIG. 1, the system according to the embodiment of the present invention includes a client device 10 and a server device 20. In addition, the client device 10 and the server device 20 are communicatively connected through a network N such as a local area network (LAN) and the Internet, for example.

The server device 20 is a computer or a computer system that provides a web application. The web application provided by the server device 20 is software (application) to be tested.

The client device 10 is a device that supports a test of the web application provided by the server device 20. Specifically, the client device 10 is a device that generates a variation of a test script of the test of equivalence partitioning and boundary value analysis. Note that while a personal computer (PC) or the like is used as the client device 10, this is not a limitative, and a smart phone, a tablet terminal, or the like may be used, for example.

Note that the overall configuration of the system illustrated in FIG. 1 is an example, and other configurations may be employed. For example, the system according to the embodiment of the present invention may include a plurality of the client devices 10 and/or a plurality of the server devices 20.

Overview of Variation Generation of Test Script

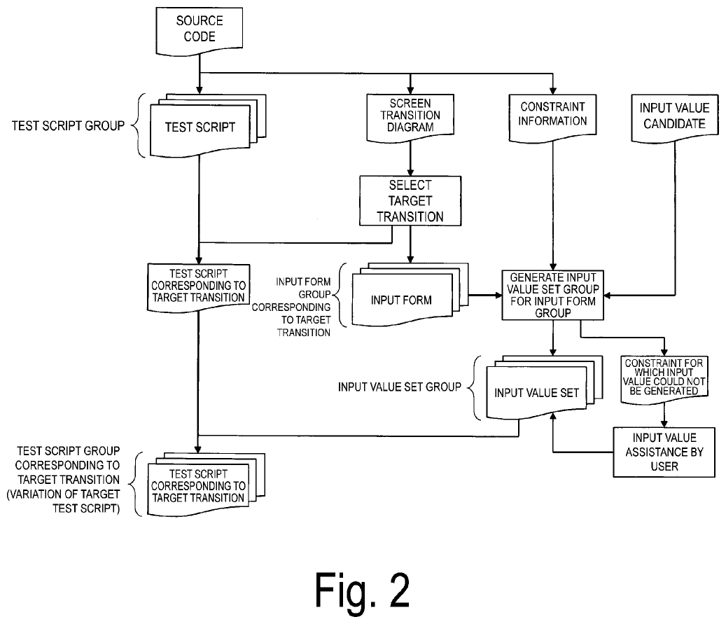

Next, an overview of a case where the client device 10 generates a variation of a test script will be described with reference to FIG. 2. FIG. 2 is a diagram illustrating an overview of a variation generation of a test script.

First, the client device 10 performs static analysis and dynamic analysis with the source code of the web application as an input to generate a screen transition diagram representing a transition relationship between each screen, and a test script group that is a collection of test scripts corresponding to screen transitions. The screen transition diagram and the test script group may be generated by a technique described in Japanese Unexamined Patent Application 2018-116496, for example. The embodiment of the present invention will be described on the premise that the screen transition diagram and the test script group described above have been generated by the technique described in Japanese Unexamined Patent Application Publication No. 2018-116496.

The user of the client device 10 selects or designates a screen transition for which to generate a variation of a test script (hereinafter, also referred to as a “target transition”) from among the screen transitions on the screen transition diagram. In this manner, from the test script group, the test script corresponding to the target transition (hereinafter, also referred to as the “target test script”) is identified, and an input form group corresponding to the target transition is identified. Note that the input form group corresponding to the target transition refers to a collection of input forms included in the screen of the transition source. In addition, the client device 10 creates constraint information by extracting a constraint related to the input value from the source code of the web application.

Next, the client device 10 uses the constraint information and an input value candidate to generate an input value set group that is a collection of input value sets for the input form group. Here, the input value candidate refers to a preliminarily prepared collection of input values.

At this time, for the constraint for which the input value could not be generated, information for requesting assistance in generation of the input value is output to the user of the client device 10. When the user performs entry of the input value or the like in response to this, the input value set is complemented.

Then, by setting each input value set included in the input value set group for the target test script, a target test script corresponding to each input value set is generated. In this manner, as a variation of the target test script, a test script group composed of the target test scripts (hereinafter, referred to also as a “target test script group”) is generated.

Hardware Configuration of Client Device 10

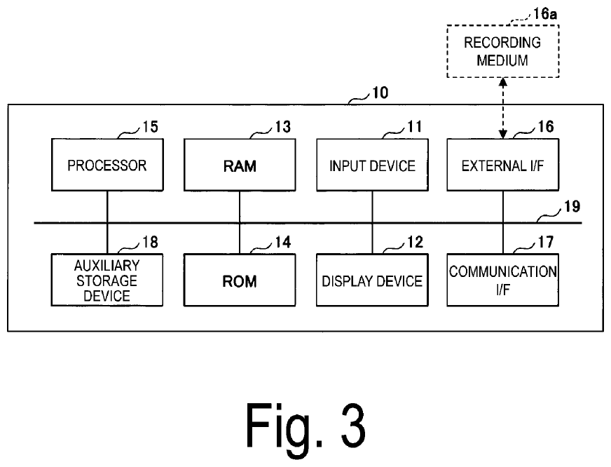

Next, a hardware configuration of the client device 10 according to the embodiment of the present invention will be described with reference to FIG. 3. FIG. 3 is a diagram illustrating an example of a hardware configuration of the client device 10 according to the embodiment of the present invention.

As illustrated in FIG. 3, the client device 10 according to the embodiment of the present invention includes, as hardware, an input device 11, a display device 12, a random access memory (RAM) 13, a read only memory (ROM) 14, a processor 15, an external I/F 16, a communication I/F 17, and an auxiliary storage device 18. The hardware is communicably connected through a bus 19.

The input device 11 is, for example, a keyboard, a mouse, a touch panel, and the like, and is used by the user to enter various operations. The display device 12 is, for example, a display and the like, and is used to display results of various processes and the like to the user.

The RAM 13 is a volatile semiconductor memory that temporarily retains a program and data. The ROM 14 is a non-volatile semiconductor memory that can retain a program and data even when the power is turned off. The processor 15 is, for example, a central processing unit (CPU) and the like, and reads a program or data from the ROM 14, auxiliary storage device 18 and the like to the RAM 13 to execute a process.

The external I/F 16 is an interface to an external device. The external device is a recording medium 16a and the like. Examples of the recording medium 16a include a compact disc (CD), a digital versatile disk (DVD), a secure digital memory card (SD memory card), and a universal serial bus (USB) memory card. One or more programs and the like that achieve each function of the client device 10 may be recorded in the recording medium 16a.

The communication I/F 17 is an interface for connecting the client device 10 to the network N. The client device 10 can perform data communication with the server device 20 through the communication I/F 17.

The auxiliary storage device 18 is a non-volatile storage device such as a hard disk drive (HDD) and a solid state drive (SSD), for example. One or more programs and the like that achieve each function of the client device 10 are recorded in the auxiliary storage device 18.

With the hardware configuration illustrated in FIG. 3, the client device 10 according to the embodiment of the present invention can achieve various processes described later. Note that while FIG. 3 illustrates a case where the client device 10 according to the embodiment of the present invention is achieved with one information processing device (computer), the present invention is not limited to this. The client device 10 according to the embodiment of the present invention may be achieved by a plurality of information processing devices (computers).

Functional Configuration of Client Device 10

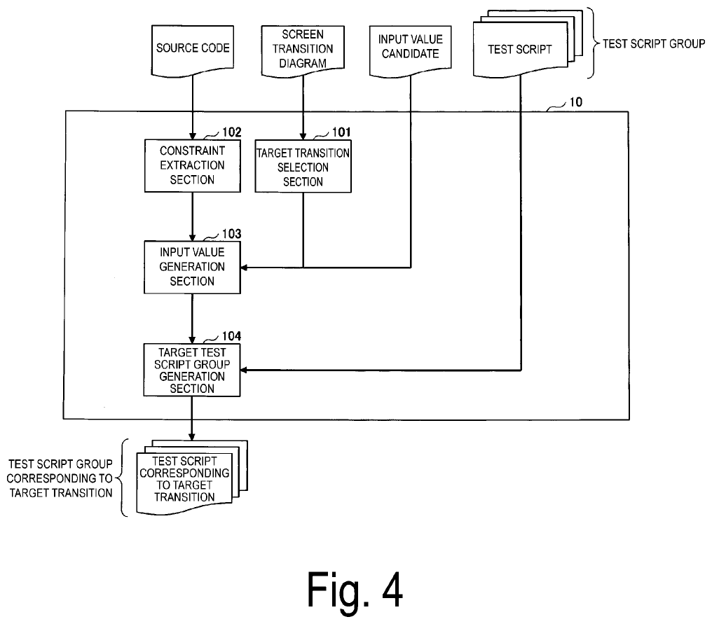

Next, a functional configuration of the client device 10 according to the embodiment of the present invention will be described with reference to FIG. 4. FIG. 4 is a diagram illustrating an example of a functional configuration of the client device 10 according to the embodiment of the present invention.

As illustrated in FIG. 4, the client device 10 according to the embodiment of the present invention includes, as function units, a target transition selection section 101, a constraint extraction section 102, an input value generation section 103, and a target test script group generation section 104. The function units are achieved by processes executed by the processor 15 with one or more programs installed in the client device 10.

The target transition selection section 101 receives selection or designation of the target transition from among the screen transitions on the screen transition diagram. Note that, when a plurality of target transitions is selected or designated, the target transition selection section 101 receives selection or designation of the plurality of target transitions. In addition, when the target transition is selected or designated, the input form group included in the screen of the transition source (i.e., the input form group in the form tag including a button, a link, or the like that is a trigger of transition to the transition destination screen) is identified.

The constraint extraction section 102 extracts a constraint from the source code of the web application and creates constraint information that includes the extracted constraint. Note that the constraint is broadly classified into a single item constraint and a correlative item constraint. The single item constraint is a constraint representing a condition that should be independently satisfied by one input value, and the correlative item constraint is a constraint representing a condition that should be satisfied among a plurality of input values. For example, the single item constraint may be “only double-width katakana should be entered into furigana field” or the like. For example, the multi-item constraint may be “date in start date field should be before date in end date field” or the like.

Here, the constraint can be freely described in the source code, and it is therefore difficult to automatically acquire (extract) constraints related to common input values. In view of this, the embodiment of the present invention focuses on the framework used in web application development (e.g., Spring Framework, Apache Struts and the like). A framework of a web application often provides a scheme or a function (validator) based on an assumed recommended way of writing a constraint. For example, Bean Validation API is provided in Spring Framework and validation.xml is provided in Apache Struts.

In view of this, the constraint extraction section 102 parses (analyzes) the source code and extracts the description for utilizing the above-described scheme or function (validator) as a constraint.

For example, in Bean Validation API, a constraint is defined by imparting an annotation. Specifically, for example, a constraint “a character string name has a minimum length of 1 and a maximum length of 20, and no null character” is defined as follows.

@NotNull

@Size (min=1, max=20)
Private String name;
In the above-described example, “@NotNull” and “@Size (min=1, max=20)” are annotations, and these annotations are imparted to “name” so as to define the above-described constraint.

In this manner, the constraint extraction section 102 parses (analyzes) the source code and extracts a constraint from the description specification set or defined by the validator provided by the framework of the web application. That is, the constraint extraction section 102 functions as a parser that extracts or acquires a constraint from a source code. Thus, when a framework of a web application provides a validator and the constraint extraction section 102 is implemented as a parser corresponding to the framework, it is possible to extract a constraint from a source code developed using any framework and the like.

Note that when the framework does not provide a validator or the like, the developers may independently implement a constraint. In this case, basically, the constraint extraction section 102 cannot extract the independently implemented constraint, but can extract the independently implemented constraint by additionally introducing a module, a plugin and the like that can analyze the independently implemented constraints, for example.

The input value generation section 103 uses constraint information and an input value candidate to generate an input value set group that is a collection of input value sets for an input form group. Note that the input value candidate is given in advance by the user and the like.

Here, the input value generation section 103 generates each input value included in the input value set on the basis of the standpoint of the equivalence partitioning and the standpoint of the boundary value analysis.

The equivalence partitioning is a test technique in which an input value group that provides the same output result is defined as one equivalence class and all input values within the equivalence class are considered to be tested when one representative value from the equivalence class is used as an input value for a test. With the equivalence partitioning, the number of test cases can be reduced by limiting the infinite input value space. Generally, a validator provided by a framework of a web application can be divided into two classes of “constraint is satisfied” and “constraint is not satisfied”. At this time, a value that satisfies a constraint is referred to as “IN point” (or “valid equivalence”) and a value that does not satisfy a constraint is referred to as “OUT point” (or “invalid equivalence”).

The boundary value analysis is a test technique for a test using an input value around the boundary between equivalence classes. This technique is based on an empirical rule that bugs are likely to hide around the boundary value. A value on the boundary value is referred to as “ON point” and a value near the boundary value is referred to as “OFF point”.

In view of this, the embodiment of the present invention generates an input value for testing the ON points and the OFF points (the vicinity before and after the boundary value) of all of the boundary values after testing all of the equivalence classes.

For example, assume that with a constraint A “1<x and x≤10”, the screen transitions to a screen P when x satisfies the constraint A, and the screen transitions to a screen Q when x does not satisfy the constraint A. In this case, the equivalence class is two classes, a class for transition to the screen P and a class for transition to the screen Q. In addition, the boundary values are {0,1,2,9,10,11}. Here, when all of the six values are tested, it is sufficient for the test standpoint.

Note that the table below shows the above-described six values organized by the standpoint of the equivalence partitioning and the standpoint of the boundary value analysis.

TABLE 1

| Input Value | 0 | 1 | 2 | 9 | 10 | 11 |
|---|---|---|---|---|---|---|
| Equivalence | Out Point | Out Point | IN Point | IN Point | IN Point | Out Point |
| Partitioning | | | | | | |
| Boundary Value | OFF Point | ON Point | OFF Point | OFF Point | ON Point | OFF Point |
| Analysis | | | | | | |

In this manner, the input value generation section 103 generates an input value that covers the standpoint of the equivalence partitioning and the standpoint of the boundary value analysis (i.e., an input value for testing the ON points and the OFF points of all of the boundary values after testing all of the equivalence classes) with reference to the constraint associated with the input form among the constraints included in the constraint information.

Here, the constraints include not only a linear constraint such as the above-described “1<x and x≤10” (i.e., linear numeric relationships), but also a non-linear constraint and a constraint using a regular expression (i.e., constraints that are difficult to mechanically solve). When the constraint associated with the input form is a non-linear constraint and/or a constraint using a regular expression, it is difficult to mechanically generate the input value in the above-described manner. In view of this, in the embodiment of the present invention, the input value generation section 103 generates an input value in three steps.

(1) In the case of a constraint that allows for mechanical generation of an input value (e.g., a linear constraint such as “1<x and x≤10” described above), the input value generation section 103 generates an input value that covers the standpoint of the equivalence partitioning and the standpoint of the boundary value analysis. Specifically, for example, the input value generation section 103 generates the input value included in each of the equivalence classes one by one, and generates the ON point and the OFF point of the boundary value of each of the equivalence classes.

(2) In the case of a constraint that does not allow for mechanical generation of an input value unlike (1), the input value generation section 103 identifies an input value that coverts at least one of the standpoint of the equivalence partitioning and the standpoint of the boundary value analysis among the input values included in the input value candidate, and acquires (extracts) the input value.

For example, in the case where the constraint of an input form is “E-mail format and max=30”, three input values (character strings), namely, “E-mail format and 29 characters”, “E-mail format and 30 characters”, and “E-mail format and 31 characters” are required as the input that covers the standpoint of the equivalence partitioning and the boundary value analysis. Accordingly, when these input values are present in the input value candidate, the input value generation section 103 acquires (extracts) these input values from the input value candidate.

(3) When there is a standpoint for which no input value has been obtained in (2) (i.e., when the input value has not been obtained for at least one of the standpoint of the equivalence partitioning and the standpoint of the boundary value analysis for a certain constraint), the input value generation section 103 outputs, to the user, information for requesting assistance for the constraint and the standpoint for which no input value has been obtained for the constraint.

For example, when the IN point has not been obtained for a certain constraint B, information for requesting assistance for the IN point of the constraint B is output to the user. Thus, the input value is directly entered or designated by the user for the standpoint of the constraint.

Through the above-described (1) to (3), an input value can be prepared for any constraint. Specifically, an input value set is generated for each input form included in an input form group, and an input value set group is obtained.

The target test script group generation section 104 sets each input value set included in the input value set group to a target test script (i.e., the input value included in the input value set is set (or embedded) to the corresponding description of the target test script) to thereby generate a target test script corresponding to each input value set. In this manner, a target test script group is generated.

Here, although not illustrated in FIG. 4, the client device 10 also includes a function unit that generates a screen transition diagram and a test script group by entering the source code of the web application and performing static analysis and dynamic analysis. Note that the client device 10 may not include the function unit. In this case, it suffices that the client device 10 acquires and enters a screen transition diagram and a test script group generated by another device (e.g., a device connected to the client device 10 through a network).

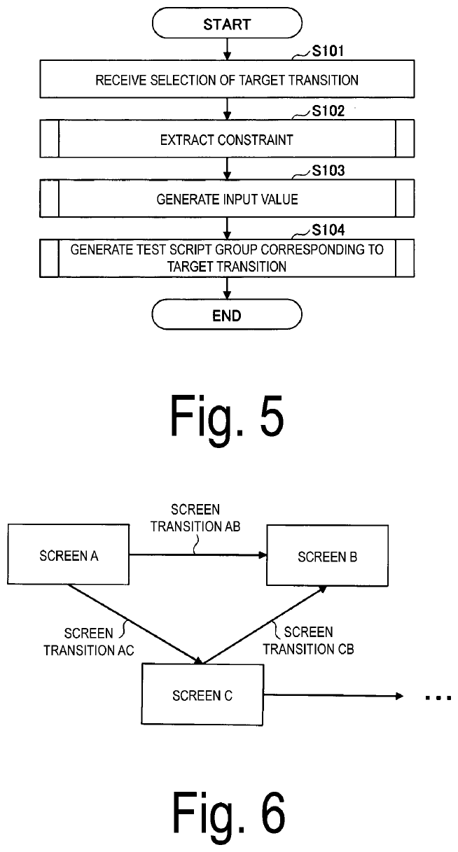

Variation Generation Process of Test Script Corresponding to Target Transition A process of generating a variation of a test script corresponding to a target transition (i.e., a target test script group) will be described below with reference to FIG. 5. FIG. 5 is a flow chart illustrating an example of a process of generating a variation of a test script corresponding to a target transition.

First, the target transition selection section 101 receives selection or designation of a target transition from among screen transitions on a screen transition diagram (step S101). Here, the screen transition diagram is a diagram illustrating a transition relationship between each screen. For example, the screen transition diagram illustrated in FIG. 6 illustrates a transition relationship between screen A, screen B, and screen C. In the example illustrated in FIG. 6, the screen transition from the screen A to the screen B is represented as “screen transition AB”, the screen transition from the screen A to the screen C is represented as “screen transition AC,” and the screen transition from the screen C to the screen B is represented as “screen transition CB”.

The user selects or designates one or more desired screen transitions (i.e., target transitions) from among the screen transitions on the screen transition. In this manner, the target transition selected or designated by the user is received by the target transition selection section 101.

Next, the constraint extraction section 102 extracts constraints from the source code of the web application and creates constraint information that includes the extracted constraints (step S102). Details of the process of step S102 (the process of extracting a constraint) will be described later.

Next, the input value generation section 103 uses the constraint information and the input value candidate to generate an input value set group that is a collection of input value sets for an input form group (step S103). Details of the process of step S103 (the process of generating an input value) will be described later.

Next, the target test script group generation section 104 generates a target test script group by setting each input value set included in the input value set group to a target test script (step S104). Details of the process of step S104 (the process of generating a test script group corresponding to a target transition) will be described later.

In the above-described manner, it is possible to obtain a target test script group in which a plurality of input value sets is set to the test script corresponding to the screen transition selected by the user. Thus, with the target test script group, the user can perform tests of various variations that cover the standpoint of the equivalence partitioning and the standpoint of the boundary value analysis.

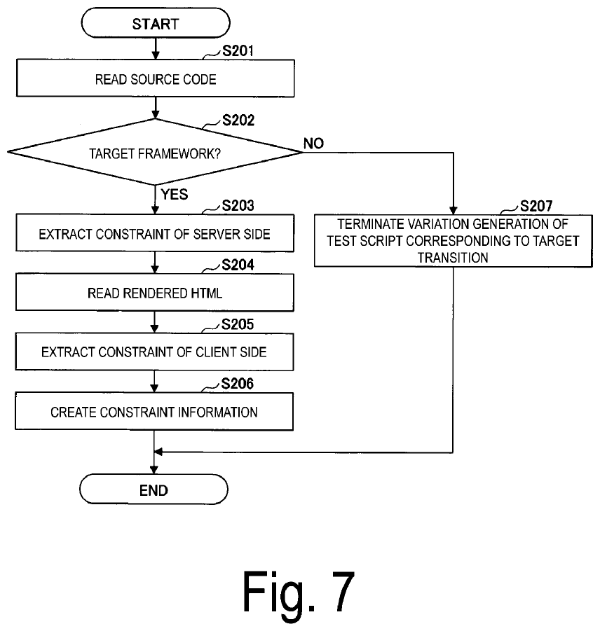

Process of Extracting Constraint Details of the process of step S102 of FIG. 7 (the process of extracting a constraint) will be described with reference to FIG. 5. FIG. 7 is a flowchart illustrating an example of the process of extracting a constraint.

The constraint extraction section 102 reads the source code of the web application (step S201). Next, the constraint extraction section 102 determines whether the framework of the web application is the target framework (step S202). Here, the target framework refers to a framework that allows for extraction of a constraint using the constraint extraction section 102 functioning as a parser. Note that whether the framework is the target framework can be determined based on the description in the source code (e.g., “package sentence” and the like), for example.

In accordance with a determination that the framework is the target framework (YES in step S202), the constraint extraction section 102 parses (analyzes) the source code and extracts a constraint of the server side among the constraints related to the target transition (i.e., the constraints that are subjected to the determination or the verification when the target transition is performed) (step S203). Note that the constraint of the server side refers to a constraint that is determined (or verified) whether the condition is satisfied on the server side.

Next, the constraint extraction section 102 reads a rendered hypertext markup language (HTML) (step S204). Note that the HTML to be rendered includes, for example, java (registered trademark) server pages (JSP) and PHP, and is a source code described by a HTML tag, an HTML output from a servlet, or the like.

Next, the constraint extraction section 102 parses (analyzes) the source code and extracts the constraint of the client side among the constraints related to the target transition (step S205).

Then, the constraint extraction section 102 creates constraint information including the constraint extracted in the step S203 and the step S205 (step S206).

In accordance with a determination that the framework is not the target framework (NO in step S202), the client device 10 terminates the variation generation process of the test script corresponding to the target transition (step S207). The reason for this is that in this case, the constraint cannot be automatically extracted from the source code.

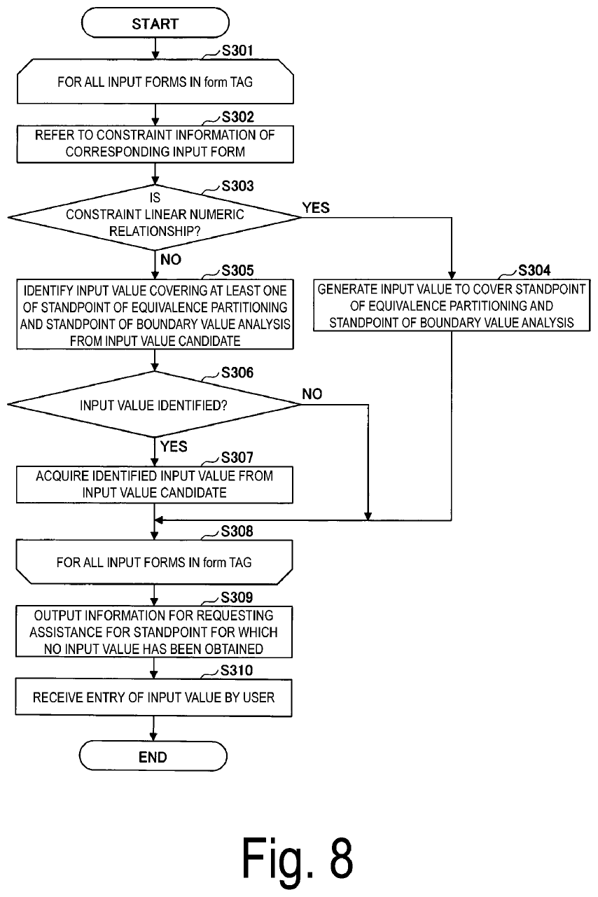

Process of Generating Input Value Details of the process of step S103 of FIG. 5 (the process of generating an input value) will be described below with reference to FIG. 8. FIG. 8 is a flowchart illustrating an example of the process of generating an input value.

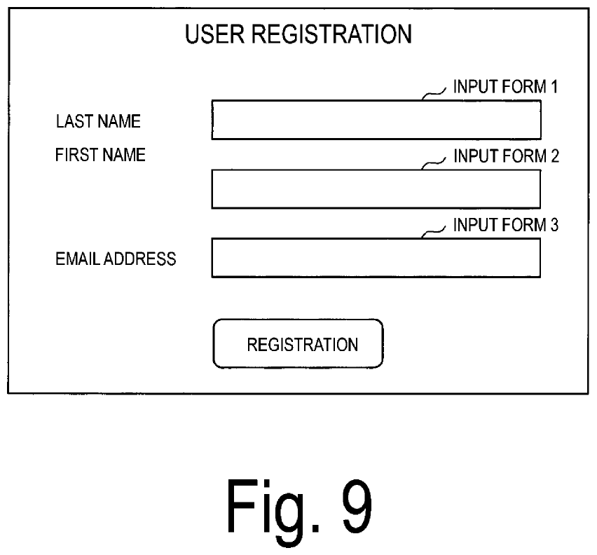

The input value generation section 103 executes the processes of step S301 to step S308 for each input form (i.e., each input form included in the input form group) in the form tag defined by the HTML rendered in the step S204. Here, when the HTML (i.e., the screen) rendered in the step S204 is as illustrated in FIG. 9, the input form in the form tag is “input form 1”, “input form 2”, and “input form 3”. Accordingly, in this case, the processes of step S301 to step S308 are executed on the “input form 1”, the “input form 2”, and the “input form 3”. Hereinafter, for the sake of simplicity, a certain input form is fixed to describe the processes of step S301 to step S308.

The input value generation section 103 refers to the constraint of the corresponding input form among the constraints included in the constraint information (step S302) and determines whether the constraint is a linear numeric relationship (step S303).

In accordance with determination that the constraint is a linear numeric relationship (YES in step S303), the input value generation section 103 generates an input value that covers the standpoint of the equivalence partitioning and the standpoint of the boundary value analysis (step S304). Thus, a plurality of input values that covers the standpoint of the equivalence partitioning and the standpoint of the boundary value analysis is generated for the constraint of the input form.

In accordance with determination that the constraint is not a linear numeric relationship (NO in step S303), the input value generation section 103 identifies, from among the input value candidates, one or more input values that cover at least one of the standpoint of the equivalence partitioning and the standpoint of the boundary value analysis (step S305). Note that in this case, the constraint is a non-linear constraint or a constraint using a regular expression, for example.

Next, the input value generation section 103 determines whether the input value has been identified in the step S305 (step S306).

In accordance with determination that the input value is identified in the step S305 (YES in step S306), the input value generation section 103 acquires (extracts) the identified one or more input values from the input value candidates (step S307). Thus, the one or more input values serve as input values of the standpoint identified as being satisfied in the step S305 for the constraint of the input form.

In accordance with determination that the input value is not identified in the step S305 (NO in step S306), the client device 10 proceeds to step S308. In this case, the input value is obtained only through entry, designation and the like by the user for the constraint of the input form.

The input value generation section 103 outputs, to the user, information for requesting assistance for the standpoint for which no input value has been obtained (step S309). Here, it suffices that the information is information including an input form in which a standpoint for which no input value has been obtained is present, a constraint of the input form, and the standpoint, for example. It suffices that the output destination of the information is the display device 12 or the like, for example.

Next, the input value generation section 103 receives entry of one or more input values entered by the user in accordance with the information output in the step S309 (step S310). Thus, the input value is complemented by the user input even for the constraint for which no input value has been obtained for some or all of the standpoints. That is, the input value set is generated for each input form included in the input form group, and an input value set group that is a collection of the input value set is obtained. Here, the input value set is a collection of input values for each of the input forms included in the input form group. Therefore, the input value set group is a variation of the input value set.

Note that when the input value is obtained for the standpoints of both the equivalence partitioning and the boundary value analysis for the constraints of all of the input forms in the processes of the step S301 to the step S308, the processes of the step S309 and the step S310 may not be executed.

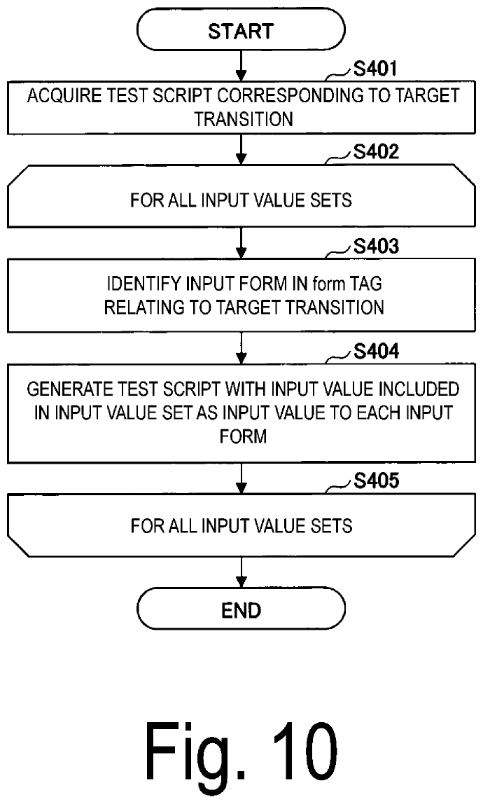

Process of Generating Test Script Group Corresponding to Target Transition Details of the process of step S104 of FIG. 5 (the process of generating a test script group corresponding to a target transition) will be described below with reference to FIG. 10. FIG. 10 is a flow chart illustrating an example of the process of generating a test script group corresponding to a target transition.

The target test script group generation section 104 acquires the test script corresponding to the target transition (i.e., the target test script) among the test script group (step S401). Note that, as described above, in the test script group and the screen transition diagram generated by the technique described in Japanese Unexamined Patent Application 2018-116496, each screen transition on the screen transition diagram and each test script included in the test script group correspond to each other, and therefore the test script corresponding to the target transition (i.e., the target test script) can be identified and acquired when the target transition is selected or designated.

The target test script group generation section 104 executes the processes of step S402 to step S406 for each input value set included in the input value set group generated in the process of generating the input value in FIG. 8. Hereinafter, for simplicity, a certain input value set is fixed to describe the processes of step S402 to step S405.

The target test script group generation section 104 identifies the input form in the form tag relating to the target transition among the input forms in the form tag of the HTML rendered in step S204 of FIG. 7 (step S403).

Next, the target test script group generation section 104 generates a target test script with the input values for each of the input forms identified in the step S403 as corresponding input values of the input values included in the input value set group (step S404). In this manner, one target test script is generated. Accordingly, when the processes of step S402 to step S405 are executed on all of the input value sets, a target test script group is generated.

### CONCLUSION

As described above, the client device 10 according to the embodiment of the present invention automatically generates a variation of an input value that covers the standpoints of the equivalence partitioning and boundary value analysis, which are important test standpoints for a test of a web application. In addition, at this time, the client device 10 according to the embodiment of the present invention automatically generates an input value when the constraint of the input form is a linear constraint, and attempts to acquire an input value from the input value candidates when the constraint is a non-linear constraint or a constraint using a regular expression. Then, when there is a standpoint for which no input value has been obtained for a certain input form, a request for entry of an input value to the input form is made to the user. In this manner, according to the embodiment of the present invention, a variation of the input value that covers the standpoints of the equivalence partitioning and the boundary value analysis can be obtained while significantly reducing the person-hours of creating input values by the user and the like.

In the client device 10 according to the embodiment of the present invention, the variation of the input value obtained in the above-described manner is used to create a variation of a test script. Thus, a variation test of a web application can be easily performed by executing the test script obtained as a variation.

The present invention is not limited to the disclosure of above-described embodiment, and various modifications and alterations may be made without departing from the scope of the claims.

### REFERENCE SIGNS LIST

10 Client device
20 Server device
101 Target transition selection section
102 Constraint extraction section
103 Input value generation section
104 Target test script group generation section

1. A test data generation device configured to generate test data of a test related to screen transitions provided by a web application, the test data generation device comprising:
a selection receiver configured to receive selection of one or more screen transitions among the screen transitions;
an extractor configured to extract a constraint from a source code of the web application by analyzing the source code by using a description specification of a constraint set or defined by a framework of the web application; and
a generator configured to generate a plurality of test data that cover test standpoints of equivalence partitioning and boundary value analysis by using the constraint of an input form included in a screen of a transition source of the one or more screen transitions that are selected.

2. The test data generation device according to claim 1, wherein
the constraint is a linear constraint, a non-linear constraint, or a constraint using a regular expression;
when the constraint is the linear constraint, the generator generates the plurality of test data that cover the test standpoints of equivalence partitioning and boundary value analysis;
when the constraint is the non-linear constraint or the constraint using the regular expression, the generator acquires one or more test data that cover the test standpoints of equivalence partitioning and boundary value analysis from among a preliminarily provided test data candidate collection; and
when the one or more test data that cover the test standpoints of equivalence partitioning and boundary value analysis are not acquired, the generator outputs information for requesting entry or designation of test data to a user.

3. The test data generation device according to claim 1, further comprising a script generator configured to set the plurality of test data generated by the generator to a test script for executing the test related to the screen transitions, and generate a plurality of test scripts to which each of the plurality of test data is set.

4. The test data generation device according to claim 1, wherein the extractor uses a description specification of a constraint independently set or defined by a developer of the web application to analyze the source code of the web application and extract a constraint from the source code.

5. A test data generation method, at a test data generation device configured to generate test data of a test related to screen transitions provided by a web application, including:
receiving, by a selection receiver, selection of one or more screen transitions among the screen transitions;
extracting, by an extractor, a constraint from a source code of the web application by analyzing the source code by using a description specification of a constraint set or defined by a framework of the web application; and
generating, by a generator, a plurality of test data that cover test standpoints of equivalence partitioning and boundary value analysis by using the constraint of an input form included in a screen of a transition source of the one or more screen transitions that are selected.

6. A computer-readable non-transitory recording medium storing computer-executable program instructions, for generating test data of a test related to screen transitions provided by a web application, that when executed by a processor cause a computer system to:
receive, by a selection receiver, selection of one or more screen transitions among the screen transitions;
extract, by an extractor, a constraint from a source code of the web application by analyzing the source code by using a description specification of a constraint set or defined by a framework of the web application; and
generate, by a generator a plurality of test data that cover test standpoints of equivalence partitioning and boundary value analysis by using the constraint of an input form included in a screen of a transition source of the one or more screen transitions that are selected.

7. The test data generation device according to claim 2, wherein,
when the one or more test data that cover the test standpoints of equivalence partitioning and boundary value analysis are not acquired, receiving the entry or the designation of test data.

8. The test data generation device according to claim 2, further comprising a script generator configured to set the plurality of test data generated by the generator to a test script for executing the test related to the screen transitions, and generate a plurality of test scripts to which each of the plurality of test data is set.

9. The test data generation device according to claim 2, wherein the extractor uses a description specification of a constraint independently set or defined by a developer of the web application to analyze the source code of the web application and extract a constraint from the source code.

10. The test data generation method according to claim 5,
wherein
the constraint is a linear constraint, a non-linear constraint, or a constraint using a regular expression;
when the constraint is the linear constraint, the generator generates the plurality of test data that cover the test standpoints of equivalence partitioning and boundary value analysis;
when the constraint is the non-linear constraint or the constraint using the regular expression, the generator acquires one or more test data that cover the test standpoints of equivalence partitioning and boundary value analysis from among a preliminarily provided test data candidate collection; and
when the one or more test data that cover the test standpoints of equivalence partitioning and boundary value analysis are not acquired, the generator outputs information for requesting entry or designation of test data to a user.

11. The test data generation method according to claim 5, wherein the extractor uses a description specification of a constraint independently set or defined by a developer of the web application to analyze the source code of the web application and extract a constraint from the source code.

12. The test data generation method according to claim 5, further comprising setting, by a script generator, the plurality of test data generated by the generator to a test script for executing the test related to the screen transitions, and generate a plurality of test scripts to which each of the plurality of test data is set.

13. The test data generation method according to claim 10, wherein
when the one or more test data that cover the test standpoints of equivalence partitioning and boundary value analysis are not acquired, receiving the entry or the designation of test data.

14. The test data generation method according to claim 10, further comprising, setting, by a script generator, the plurality of test data generated by the generator to a test script for executing the test related to the screen transitions, and generate a plurality of test scripts to which each of the plurality of test data is set.

15. The test data generation method according to claim 10, wherein the extractor uses a description specification of a constraint independently set or defined by a developer of the web application to analyze the source code of the web application and extract a constraint from the source code.

16. The computer-readable non-transitory recording medium according to claim 6, wherein
the constraint is a linear constraint, a non-linear constraint, or a constraint using a regular expression;
when the constraint is the linear constraint, the generator generates the plurality of test data that cover the test standpoints of equivalence partitioning and boundary value analysis;
when the constraint is the non-linear constraint or the constraint using the regular expression, the generator acquires one or more test data that cover the test standpoints of equivalence partitioning and boundary value analysis from among a preliminarily provided test data candidate collection; and
when the one or more test data that cover the test standpoints of equivalence partitioning and boundary value analysis are not acquired, the generator outputs information for requesting entry or designation of test data to a user.

17. The computer-readable non-transitory recording medium according to claim 6, wherein the extractor uses a description specification of a constraint independently set or defined by a developer of the web application to analyze the source code of the web application and extract a constraint from the source code.

18. The computer-readable non-transitory recording medium according to claim 6, the computer-executable program instructions when executed further causing the system to: set, by a script generator, the plurality of test data generated by the generator to a test script for executing the test related to the screen transitions, and generate a plurality of test scripts to which each of the plurality of test data is set.

19. The computer-readable non-transitory recording medium according to claim 16, wherein
when the one or more test data that cover the test standpoints of equivalence partitioning and boundary value analysis are not acquired, receiving the entry or the designation of test data.

20. The computer-readable non-transitory recording medium according to claim 16, the computer-executable program instructions when executed further causing the system to:
set, by a script generator, the plurality of test data generated by the generator to a test script for executing the test related to the screen transitions, and generate a plurality of test scripts to which each of the plurality of test data is set.
